(19) United States
(12) Patent Application Publication
(10) Pub. No.: US 2021/0341092 A1
(43) Pub. Date: Nov. 4, 2021

(54) BIAXIAL TILTING DEVICE, CAMERA DEVICE, AND ELECTRONIC APPARATUS

(71) Applicant: New Shicoh Motor Co., Ltd., Zhejiang (CN)

(72) Inventor: Kokichi Terajima, Kanagawa (JP)

(21) Appl. No.: 17/213,342

(22) Filed: Mar. 26, 2021

(30) Foreign Application Priority Data
Apr. 30, 2020 (CN) 202010364229.9

(51) Int. Cl. F16M 11/18; G03B 17/56; H02K 41/035; F16M 11/14

(52) U.S. Cl. CPC F16M 11/18; G03B 17/561; H02K 2201/18; F16M 11/14; H02K 41/0356

(57) ABSTRACT

Provided is a biaxial tilting device, a camera device, and an electronic apparatus, which enable suppression of shaking of a camera unit. A biaxial tilting device includes: a frame body including a back plate opposed to a bottom surface of a member to be tilted across a space: a suspension spring, which is arranged in the space to connect the bottom surface and the back plate to each other, and is configured to support the member to be tilted in such a manner as to allow tilt of the member to be lilted with respect to the back plate: and a tilting and driving mechanism configured to drive the member to be tilted to tilt the member to be tilted with respect to the back plate.

### BACKGROUND OF THE INVENTION

The present invention relates to a biaxial tilting device, a camera device, and an electronic apparatus.

There is known an image shooting device for, for example, a dashboard camera to be mounted to a vehicle, which includes a camera unit and a holder configured to support the camera unit (Japanese Patent Application Laid-open No. 2012-244614).

A dashboard camera to be mounted to a vehicle includes a camera unit. The camera unit is directly mounted to the vehicle, and hence is liable to be shaken due to vibration and shock, which may be caused while the vehicle is running. As a result, a clear image may not be recorded.

### SUMMARY

The present invention has an object to provide a biaxial tilting device, a camera device, and an electronic apparatus, which enable suppression of shaking of a camera unit.

According to one aspect of the present invention, there is provided a biaxial tilting device, including: a frame body including a back plate opposed to a bottom surface of a tiltable target member across a space; a suspension spring, which is arranged in the space to connect the bottom surface and the back plate to each other, and is configured to support the tiltable target member in such a manner as to allow tilt of the tiltable target member with respect to the back plate; and a tilting and driving mechanism configured to drive the tiltable target member to tilt the tillable target member with respect to the back plate.

Further, it is preferred that the suspension spring include a spring main body portion having one of a spiral spring shape and a coil spring shape, which turns around about an axial direction perpendicular to the back plate.

Further, it is preferred that the spring main body portion have a plate surface that is substantially parallel to the back plate.

Further, it is preferred that the suspension spring have mounting portions that are formed at both ends of the spring main body portion to extend in the axial direction, respectively, and the mounting portions include: a first mounting portion, which is formed at one of the ends of the spring main body portion, an is connected to the back plate; and a second mounting portion, which is formed at another one of the ends, and is connected to the bottom surface of the tiltable target member.

Further, it is preferred that the spring main body portion be in ion-contact with the bottom surface of the tiltable target member and the back plate.

Further, it is preferred that one of a magnet and a drive coil, which serves as the tilting and driving mechanism, be arranged on each of side surfaces of the tiltable target member, and another one of the magnet and the drive coil be arranged on each of inner surfaces of the frame body.

According to another aspect of the present invention, the suspension spring includes a main body portion, and wherein the main body portion is formed by punching a metal plate body, and has a spiral spring shape with a turn that turns around about an axial direction perpendicular to the back plate in a plane.

According to another aspect of the present invention, there is provided a camera device, including: the biaxial tilting device of the above-mentioned invention; and a camera unit corresponding to the tillable target member.

According to another aspect of the present invention, there is provided an electronic apparatus including the biaxial tilting device of the above-mentioned invention or the camera device of the above-mentioned invention.

According to the present invention, the tiltable target member, which corresponds to the camera unit, is suspended through the suspension spring in such a manner as to be tiltable with respect to the back plate of the frame body. Further, the tilting and driving mechanism drives the tiltable target member to tilt the tiltable target member. In this manner, shaking of the tillable target member can be suppressed.

### BRIEF DESCRIPTION OF THE DRAWINGS

FIG. 1 is an outside perspective view of a dashboard camera according to an embodiment.

FIG. 2 is an exploded perspective view of the dashboard camera of FIG. 1 when viewed in a direction opposite to the direction in which the dashboard camera is viewed in FIG. 1.

FIG. 3 is an outside perspective view of a suspension spring.

### DESCRIPTION OF THE EMBODIMENT

An embodiment of the present invention is described with reference to the accompanying drawings. In the embodiment described below, a biaxial tilting device, a camera device, and an electronic apparatus according to the present invention are exemplified. Thus, the present invention is not intended to be limited to the embodiment described below.

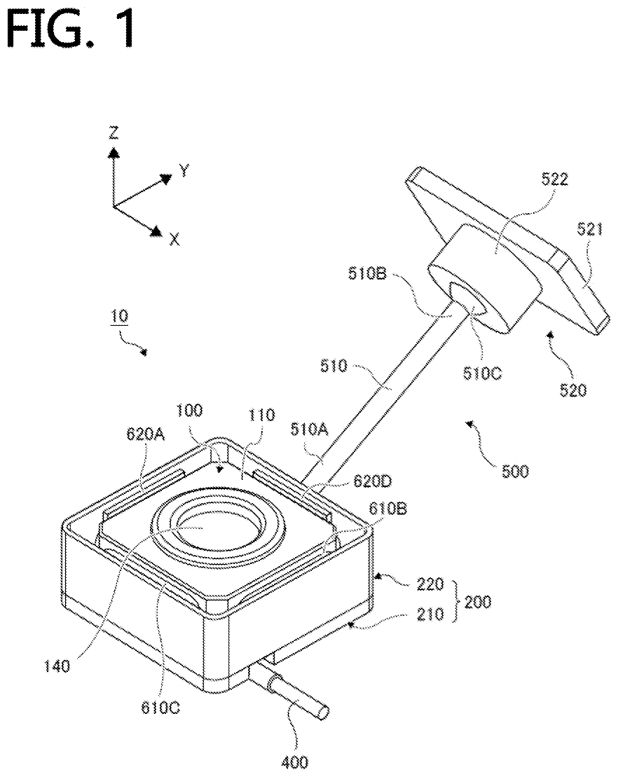

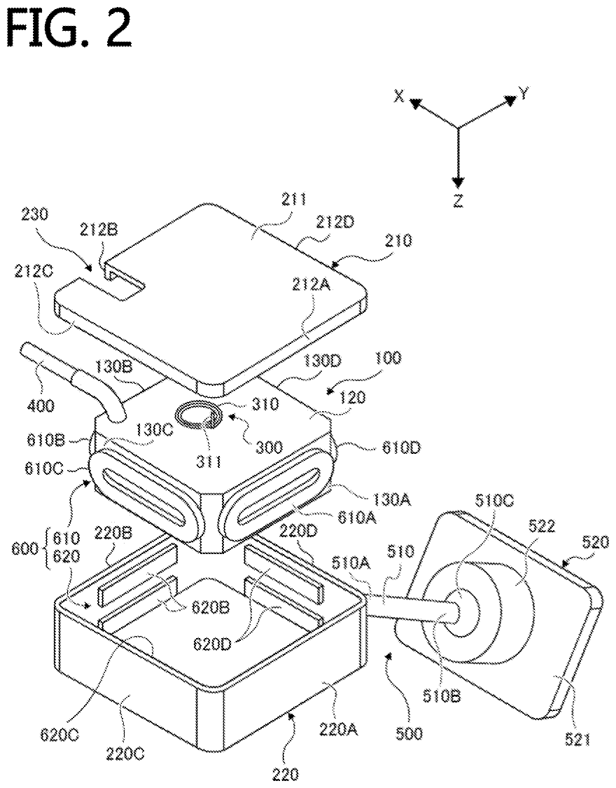

As illustrated in FIG. 1 and FIG. 2, a dashboard camera 10 corresponding to an electronic apparatus according to this embodiment includes a camera device and a mounting member 500. The camera device includes a camera unit 100 and a biaxial tilting device. The camera unit 100 corresponds to a member to be tilted (a tilted member). The biaxial tilting device is configured biaxially tilt the camera unit 100. A power cable 400 is connected to the camera unit 100. The biaxial tilling device includes a frame body 200, a suspension spring 300, and a tilting and driving mechanism. The frame body 200 surrounds the camera unit 100. The suspension spring 300 connects the camera unit 100 and the frame body 200 to each other. The tilting and driving mechanism is configured to tilt the camera unit 100. The tilting and driving mechanism includes a current supply control unit (not shown) and a tilting and driving device 600, which are described later.

The camera unit 100 is formed as a box body having a cuboidal shape. The camera unit 100 has a front surface 110, a bottom surface 120, and four side surfaces 130A to 130D. The front surface 110 having a substantially square shape extends in an X-Y plane direction. The bottom surface 120 is parallel to the front surface 110. The front surface 110 and the bottom surface 120 have substantially the same shape and the same dimensions. Each of the front surface 110 and the bottom surface 120 may have an oblong shape. Each of the four side surfaces 130A to 130D has an oblong shape having substantially the same size with a predetermined height in a Z-axis direction and a predetermined length in a Y-axis direction or an X-axis direction. Each of the side surfaces 130A and 130B extends in a Y-Z plane direction, and each of the side surfaces 130C and 130D extends in an X-Z plane direction.

A lens 140 having the Z-axis direction as its optical axis direction is arranged on the front surface 110. Further, an image pickup element (not shown) configured to receive light that is reflected from an object to pass through the lens 140 is arranged in parallel to the lens 140 inside the camera unit 100. The current supply control unit configured to supply a current to a coil of the tilting and driving device 600 described later is provided inside the camera unit 100. Further, a recording medium storage portion (not shown) or a video image control unit not shown) may be provided inside the camera unit 100. The recording medium storage portion is configured to store a recording medium such as an SD card. The video image control unit is configured to process a video image taken by the image pickup, element and store the video image in the recording medium.

The frame body 200 includes a back-side frame body 210 and a frame-body side plate set 220. The back-side frame body 210 includes a back plate 211 having a rectangular shape and four back-side side plates 212A to 212D. The back plate 211 extends in the X-Y plane direction. The back-side side plates 212A to 212D extend from peripheral edge portions of the back plate 211 along the Z-axis direction. The back plate 211 has a size larger than a size of the bottom surface 120 of the camera unit 100 described above. Specifically, lengths oldie back plate 211 in the X-axis direction and the Y-axis direction are larger than lengths of the bottom surface 120 in the X-axis direction and the Y-axis direction, respectively.

The frame-body side plate set 220 is a hollow tubular member that surrounds the camera unit 100 and has two open sides in the Z-axis direction. The frame-body side plate set 220 includes four frame-body side plates 220A to 220D. A length of each of the frame-body side plates 220A and 220B in the Y-axis direction is equal to a length of each of the back-side side plates 212A and 212B in the Y-axis direction, and a length of each of the frame-body side plates 220C and 220D in the X-axis direction is equal to a length of each of the back-side side plates 212C and 212D in the X-axis direction. Further, the length of each of the frame-body side plates 220A and 220B in the Y-axis direction is larger than a length of each of the side plates 130A and 130B of the camera unit 100 in the Y-axis direction, and the length of each of the frame-body side plates 220C and 220D in the X-axis direction is larger than a length of each of the side surfaces 130C and 130D in the X-axis direction. Thus, when the camera unit 100 is arranged inside the frame body 200, the side surfaces 130A to 130B are opposed to the frame-body side plates 220A to 220D across a space without being in contact therewith, respectively.

The suspension spring 300 is arranged between the bottom surface 120 of the camera unit 100 and the back plate 211 of the frame body 200 to connect the bottom surface 120 and the back plate 211 to each other. The suspension spring 300 is arranged at a center of the bottom surface 120. The suspension spring 300 may be arranged at a position on the bottom surface 120, which corresponds to a center of gravity of the camera unit 100. Further, two or more suspension springs 300 may be arranged on the bottom surface 120.

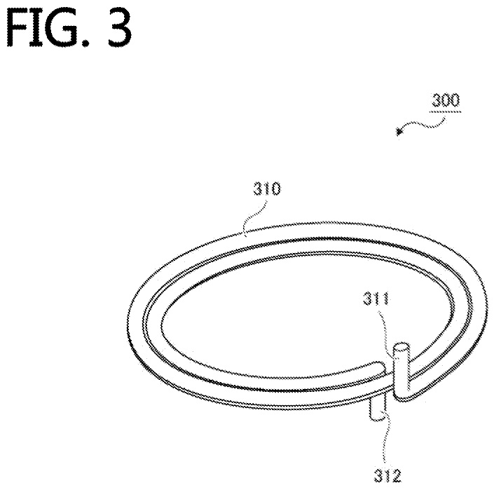

As illustrated in FIG. 3, the suspension spring 300 includes a spring main body portion 310, a first mounting portion 311, and a second mounting portion 312. The first mounting portion 311 is formed at one end of the spring main body portion 310, and is mounted to the back plate 211. The second mounting portion 312 is formed at another end of the spring main body portion 310, and is mounted to the bottom surface 120. In this embodiment, the first mounting portion 311 is formed at an outer end, and the second mounting portion 312 is formed at an inner end. The spring main body portion 310 is formed by punching, a metal plate body, and has a spiral spring shape with turns about the Z axis in the X-Y plane. The spring main body portion 310 is mounted in such a manner that a plate surface of the spring main body portion 310 extends in the X-Y plane direction. In this embodiment, the spring main body portion 310 has two turns that turn around about the Z axis between the first mounting portion 311 and the second mounting portion 312. The number of turns of the spiral may be smaller than two or larger than two. Further, it is preferred that the first mounting portion 311 and the second mounting portion 312 be arranged as close as possible to each other.

The first mounting portion 311 is a bar-shaped member, which is bent at the outer end of the spring main body portion 310 and extends in the Z-axis direction to be substantially perpendicular to the plate surface. The first mounting portion 311 is fixed and connected to the back plate 211 of the back-side frame body 210. The second mounting portion 312 is a bar-shaped member, which is bent at the inner end of the spring main body portion 310 and extends in the Z-axis direction in a direction opposite to the extending, direction of the first mounting portion 311 to be substantially perpendicular to the plate surface. The second mounting portion 312 is fixed and connected to the bottom surface 120 of the camera unit 100. At this time, the spring main body portion 310 is in non-contact with the bottom surface 120 of the camera unit 100 and the back plate 211. With the arrangement described above, the first mounting portion 311 and the second mounting portion 312 are located substantially in line. In addition, the second mounting portion 312 can be inclined about the Z-axis direction with respect to the first mounting portion 311. In other words, the second mounting portion 312 allows the camera unit 100 to be turned about the X axis and the Y axis.

The power cable 400 is connected to the bottom surface 120 of the camera unit 100. The power cable 400 is configured to supply electric power to the current supply control unit, the recording medium storage portion, and the video image control unit, which are stored in the camera unit 100. A cutout portion 230 is formed in the back-side side plate 212B and the back plate 211. The cutout portion 230 is a lead-out port for leading the power cable 400 to an outside.

The mounting member 500 includes a bar member 510 and a fixing member 520. One end 510A of the bar member 510 is fixed to the frame body 200, for example, to an outer surface of the frame-body side plate 220D. A spherical body 510C is formed at another end 510B of the bar member 510. The fixing member 520 includes a fixing plate 521 and a cylindrical portion 522. The fixing plate 521 has an attachment surface to be attached to, for example, a windshield of a vehicle. The cylindrical portion 522 projects to a side opposite to the attachment surface. The cylindrical portion 522 and the spherical body 510C form a so-called ball joint. The cylindrical portion 522 holds the spherical body 510C in an enclosing manner. The bar member 510 is supported to have a given degree of freedom that allows a direction and an angle thereof to be adjusted with respect to the fixing member 520.

The tilting and driving device 600 includes coils 610 and magnets 620. The coils 610 are arranged on the side surfaces 130A to 130D of the camera unit 100. The magnets 620 are each arranged on inner surfaces of the frame-body side plates 220A to 220D of the frame body 200. The coils 610 include first coils 610A and 610B and second coils 610C and 610D. The magnets 620 include the first magnets 620A and 620B and the second magnets 620C and 630D. More specifically, the first coils 610A and 610B are arranged on the side surfaces 130A and 130B, each being, perpendicular to the X-axis direction. Meanwhile, the second coils 610C and 610D are arranged on the side surfaces 130C and 130D, each being perpendicular to the Y-axis direction.

Each of the first coils 610A and 610B has an elliptical overall shape elongated in the Y-axis direction, and includes two linear portions and curved portions. The two linear portions extend in parallel along the Y-axis direction. The curved portions each have a C-like shape, and connect both ends of the linear portions to each other. Similarly, each of the second coils 610C and 610D has an elliptical overall shape elongated in the X-axis direction, and includes two linear portions and curved portions. The two linear portions extend in parallel along the X-axis direction. The curved portions each have a C-like shape, and connect both ends of the linear portions to each other. The first coils 610A and 610B and the second coils 610C and 610D are connected to the current supply control unit provided inside the camera unit 100.

Meanwhile, the first magnets 620A and 620B are arranged on the frame-body side plates 220A and 220B, respectively. Further, the second magnets 620C and 620D are arranged on the frame-body side plates 220C and 220D, respectively.

Each of the first magnets 620A and 620B includes two plate-shaped magnet pieces, which are each elongated in the Y-axis direction and have surfaces with magnetic polarities different from each other. The two plate-shaped magnet pieces are arranged in alignment with each other in the Z-axis direction. Each of the second magnets 620C and 620D also includes two plate-shaped magnet pieces, which are each elongated in the X-axis direction and have surfaces with magnetic polarities different from each other. The two plate-shaped magnet pieces are arranged in alignment with each other in the Z-axis direction. Thus, the linear portions of the first coil 610A are opposed to the first magnet 620A across a space, and the linear portions of the first coil 610B are opposed to the first magnet 620B across a space. The linear portions of the second coil 610C are opposed to the second magnet 620C across a space, and the linear portions of the second coil 610D are opposed to the second magnet 620D across a space. Each of the first magnets 620A and 620B and the second magnets 620C and 620D may include one magnet piece having surfaces with magnetic polarities different from each other, which are formed in division in the Z-axis direction. In this case, the magnets are opposed to the linear portions of the first coils 610A and 610B and the second coils 610C and 610D across spaces, respectively.

Assembly of the above-mentioned dashboard camera 10 according to this embodiment is now described. The power cable 400 is connected to the bottom surface 120 of the camera unit 100, and the coils 610 are mounted to the side surfaces 130A to 130D. Further, the second mounting portion 312 of the suspension spring 300 is connected to the bottom surface 120 of the camera unit 100. Meanwhile, the first mounting portion 311 of the suspension spring 300 is connected to the back plate 211 of the hack-side frame body 210. As a result, the camera unit 100 is brought into a state of being suspended from the frame body 200 through the suspension spring 300. Further, the magnets 620 are mounted onto the inner surfaces of the frame-body side plates 220A to 220D, respectively.

Next, the camera unit 100 is inserted into the frame-body side plate set 220. Then, the frame-body side plate set 220 is mounted to the back-side frame body 210. More specifically, rear ends of the frame-side side plates 220A to 220D in the Z-axis direction are brought into abutment against front ends of the back-side side plates 212A to 212D of the back-side frame body 210 in the Z-axis direction, and are fixed thereto, respectively. At this time, the power cable 400 is led to an outside of the frame body 200 through the cutout portion 230 of the back-side frame body 210. As a result, the camera unit 100 is brought into a state of being tiltable inside the frame body 200.

Further, at this time, the linear portions of the first coils 610A and 610B are opposed to the surfaces of the first magnets 620A and 620B, which have the different magnetic polarities, across the spaces, respectively. The linear portions of the second coils 610C and 610D are opposed to the surfaces of the second magnets 620C and 620D, which have the different magnetic polarities, across the spaces, respectively.

Next, the one end 510A of the bar member 510 of the mounting member 500 is fixed and connected to one frame-body side plate (the frame-body side plate 220D in FIG. 1 and FIG. 2) of the frame-body side plate set 220 of the frame body 200, and the spherical body 510C formed at the another end 510B is inserted into the cylindrical portion 522 of the fixing member 520.

Next, an operation of the dashboard camera 10 according to this embodiment is described. For example, a current is supplied from the current supply control unit to energize the coils 610. The current flowing through the coils 610 in a magnetic field generated by the magnets 620 generates an electromagnetic force in the Z-axis direction for the coils 610.

The same current is caused to flow through the first coils 610A and 610B. At this time, forces in the ±Z-axis directions opposite to each other are generated in the first coils 610A and 610B by selecting a direction of the current caused to flow and the magnetic polarities for the surfaces of the first magnets 620A and 620B. As a result, the camera unit 100 can be turned around about the Y axis.

The same operation is performed for the second coils 610C and 610D. When the same current is caused to flow through, the second coils 610C and 610D, forces in the ±Z-axis directions opposite to each other are each generated in the second coils 610C and 610D. As a result, the camera unit 100 can be pivoted about the X axis.

The current supply control unit of the camera unit 100 includes an angular velocity detection device (not shown). When vibration or a shock caused while the vehicle is running is transmitted to the camera unit 100, an angular velocity is detected by the angular velocity detection device as a component about the X axis and a component about the Y axis. The current supply control unit supplies the current to the second coils 610C and 610D and/or the first coils 610A and 610B of the camera unit 100 or adjusts the amount of supply and a direction of the current in accordance with a magnitude and a direction of the detected angular velocity of the component about the X axis and/or the component about the axis. In this manner, a force for turning the camera unit 100 about the X axis and/or the Y axis is generated, so that the camera unit 100 can be returned to an original direction about the X axis and/or the Y axis. In this manner, the camera unit 100 is isolated from shaking of the vehicle.

As the structure of the suspension spring 300, the first mounting portion 311 and the second mounting portion 312 may be formed by bending both ends of a plate body obtained through punching. Further, one wire may be formed into a spiral shape to form the spring main body portion 310, and both ends of the spring main body portion 310 may be bent to form the first mounting portion 311 and the second mounting portion 312. Further, the spring main body portion 310 may be formed not into a spiral shape but as a coil spring. Further, the embodiment has been described with an example in which the present invention is applied to the dashboard camera. However, the present invention is applicable not only to the dashboard camera but also to, for example, other camera apparatus to be mounted to a bicycle or a drone.

What is claimed is:

1. A biaxial tilting device, comprising:
a frame body including a back plate opposed to a bottom surface of a member to be tilted across a space;
a suspension spring, which is arranged in the space to connect the bottom surface and the back plate to each other, and is configured to support the member to be tilted in such a manner as to allow tilt of the member to be tilted with respect to the back plate; and
a tilting and driving mechanism configured to drive the member to be tilted to tilt the member to be tilted with respect to the back plate.

2. The biaxial tilting device according to claim 1, wherein the suspension spring includes a spring main body portion having one of a spiral spring shape and a coil spring shape, which turns around about an axial direction perpendicular to the back plate.

3. The biaxial tilting device according to claim 2, wherein the spring main body portion has a plate surface that is substantially parallel to the back plate.

4. The biaxial tilting device according to claim 2,
wherein the suspension spring has mounting portions that are formed at both ends of the spring main body portion to extend in the axial direction, respectively, and
wherein the mounting portions include:
a first mounting portion, which is formed at one of the ends of the spring main body portion, and is connected to the back plate; and
a second mounting portion, which is formed at another one of the ends, and is connected to the bottom surface of the member to be tilted.

5. The biaxial tilting device according to claim 4, wherein the spring main body portion is in non-contact with the bottom surface of the member to be tilted and the back plate.

6. The biaxial tilting device according to claim 1, wherein one of a magnet and a drive coil, which serves as the tilting and driving mechanism, is arranged on each of side surfaces of the member to be tilted, and another one of the magnet and the drive coil is arranged on each of inner surfaces of the frame body.

7. The biaxial tilting device according to claim 2, wherein one of a magnet and a drive coil, which serves as the tilting and driving mechanism, is arranged on each of side surfaces of the member to be tilted, and another one of the magnet and the drive coil is arranged on each of inner surfaces of the frame body.

8. The biaxial tilting device according to claim 3, wherein one of a magnet and a drive coil, which serves as the tilting and driving mechanism, is arranged on each of side surfaces of the member to be tilted, and another one of the magnet and the drive coil is arranged on each of inner surfaces of the frame body.

9. The biaxial tilting device according to claim 4, wherein one of a magnet and a drive coil, which serves as the tilting and driving mechanism, is arranged on each of side surfaces of the member to be tilted, and another one of the magnet and the drive coil is arranged on each of inner surfaces of the frame body.

10. The biaxial tilting device according to claim 5, wherein one of a magnet and a drive coil, which serves as the tilting and driving mechanism, is arranged on each of side surfaces oldie member to be tilted, and another one oldie magnet and the drive coil is arranged on each of inner surfaces of the frame body.

11. The biaxial tilting device according to claim 1,
wherein the suspension spring includes a main body portion, and
wherein the main body portion is formed by punching a metal plate body, and has a spiral spring shape with a turn that turns around about an axial direction perpendicular to the back plate in a plane.

12. A camera device, comprising:
a camera unit corresponding to the member to be tilted; and
the biaxial tilting device of claim 1.

13. An electronic apparatus, comprising the camera device of claim 12.
